(19) United States
(12) Patent Application Publication
(10) Pub. No.: US 2023/0026060 A1
(43) Pub. Date: Jan. 26, 2023

(54) Flexible Automatic Clamping Device and Method for Backside Laser Penetration Welding of T-shaped Structure

(71) Applicant: Nanjing University of Aeronautics and Astronautics, Nanjing (CN)

(72) Inventors: Xiaohong ZHAN, Nanjing (CN); Xufeng KANG, Nanjing (CN); Tingyan YAN, Nanjing (CN); Leilei WANG, Nanjing (CN); Danna HU, Nanjing (CN)

(21) Appl. No.: 17/868,877

(22) Filed: Jul. 20, 2022

(30) Foreign Application Priority Data
Jul. 20, 2021 (CN) 202110821906.X

(51) Int. Cl. B23K 37/04; B23K 26/21

(52) U.S. Cl. CPC B23K 37/04; B23K 26/21

(57) ABSTRACT

The disclosure relates to a flexible automatic clamping device and method for backside laser penetration welding of a T-shaped structure. The flexible automatic clamping device includes a clamping system, a ranging system and a control system. The ranging system outputs a position instruction to the control system, the control system outputs a movement instruction to the clamping system, so as to adjust the clamping system to an optimal position, then a stringer pressing plate fastens a stringer by means of a Y-shaped connecting rod, and a skin pressing plate fastens skin by means of a skin connecting rod. Based on the flexible automatic clamping device, the method includes prewelding clamping, backside laser penetration welding and postwelding shape retention. The disclosure implements accurate positioning, automatic clamping, backside laser penetration welding and postwelding shape retention of a T-shaped skin-stringer structure.

### CROSS-REFERENCE TO RELATED PRESENT INVENTION(S)

The disclosure claims priority to and the benefit of Chinese Patent Present invention No.202110821906.X, filed in the China National Intellectual Property Administration (CNIPA) on 20 Jul. 2021, which is incorporated herein by reference in its entirety.

### TECHNICAL FIELD

The disclosure relates to the technical field of laser automatic high-precision welding, and particularly relates to a flexible automatic clamping device and method.

### BACKGROUND

In the aircraft manufacture field, it's typical to connect T-shaped skin-stringer structural joints of titanium alloy in fuselage panels through a traditional riveting process. Despite its simplicity, high connection strength, perfect process and high safety, the riveting process inevitably leads to increase in structural weight due to massive use of rivets, and reduces production efficiency due to a large number of process holes to be machined on a base material. With a high energy density, desirable penetrability and air tightness, high fatigue performance, high production efficiency, and easy automation and flexibility, laser welding has been widely used in aerospace, engineering and other fields.

A laser-welded T-shaped skin-stringer structure of titanium alloy can reduce the manufacturing cost, shorten a production cycle, lighten a weight of an aircraft, improve mechanical properties of components, improve carrying capacity of the aircraft and enhance stability of the aircraft.

A double-laser-beam double-sided synchronous welding process is a primary process of laser welding of T-shaped skin-stringer structures of titanium alloy. However, in an actual production process, it is often necessary to weld a skin on a stringer. Because of apparatus interference, assembly interference, size changes of to-be-welded workpieces, etc., double-laser-beam double-sided synchronous welding is unattainable in some cases. In addition, a T-shaped skin-stringer structure is unstable, non-torsion-resistant, non-releasable, poor in flexibility and low in automation degree in a clamping process. As a result, stability of the workpieces in a welding process is poor, and accordingly, welding defects such as pores and incomplete penetration are highly possible, which reduce quality of weld seams. Further, a non-flexible automatic clamping process leads to low production efficiency of products and influences a production cycle of the aircraft.

Therefore, the disclosure provides a flexible automatic clamping device and method for backside laser penetration welding of T-shaped structure, which implements accurate positioning, automatic clamping, backside penetration welding and postwelding shape retention of a T-shaped skin-stringer structure. The method solves the problems of apparatus and assembly interference in a welding process, unstable clamping of the workpieces and post-welding distortion of the workpieces, and achieves a flexible automatic clamping process of the workpieces. In this way, the stability of the workpiece in the welding process is improved, the quality of weld seams is improved, a production cycle of the workpieces is shortened, post-welding residual stress on the workpieces is released, and the post-welding distortion of the workpieces is controlled. Ultimately, a product with high quality, excellent performance and a short cycle is obtained.

### SUMMARY

To overcome the defects in the related art, the disclosure aims to provide a flexible automatic clamping device and method for backside laser penetration welding of a T-shaped structure. The method may achieve flexible automation of a clamping process of a T-shaped skin-stringer structure, may ensure a stable, torsion-resistant and releasable clamping process, may implement backside laser penetration welding of the T-shaped skin-stringer structure in a high-quality and effective manner, and may achieve a post-welding shape retention effect.

To achieve the objectives, the specific technical solution of the disclosure is as follows:

A flexible automatic clamping device for backside laser penetration welding of a T-shaped structure is configured to flexibly clamp T-shaped structural to-be-welded parts having different sizes and different welding positions in an automatic, locked, torsion-resistant and releasable manner, and includes:
a clamping system, the clamping system includes a base plate, a central column, a ball screw, a Y-shaped connecting rod, a stringer pressing plate, a stringer, a lifting connecting rod, a skin supporting table, a skin, a gear connecting rod, a skin cover plate, a skin connecting rod, and a skin pressing plate; the base plate is provided with a guide-track groove, and the central column is placed in the guide-track groove and connected to the ball screw, so as to achieve a lateral adjustment of the central column; the Y-shaped connecting rod is arranged in the middle of the central column and connected to the stringer pressing plate, so as to clamp and fasten the stringer; the lifting connecting rod is arranged above the central column, so as to adjust a height of the skin supporting table in real time, and the skin supporting table is configured to support the skin and connected to the skin cover plate by means of the gear connecting rod, so as to open and close the skin cover plate and facilitate mounting and dismounting of the skin; and the skin cover plate is connected to the skin pressing plate by means of the skin connecting rod, so as to clamp and fasten the skin;
a ranging system, the ranging system includes a lateral laser range finder and a longitudinal laser range finder that are configured to measure and record a thickness of the stringer and a height of the skin in real time, so as to achieve accurate positioning the stringer and the skin; and
a control system, which is configured to adjust the clamping system on the basis of data measured by the ranging system, so as to position the clamping system at an optimal position; and configured to obtain an optimal pressure parameter from a database according to the obtained data, output the optimal pressure parameter to the clamping system, and implement an optimal fastening solution for the T-shaped structural to-be-welded parts.

In an implementation mode, pressing structural parts including the stringer pressing plate and the skin pressing plate are all made of high temperature resistant rubber material, so as to increase contact areas between the pressing structural parts and the stringer as well as the skin, reduce a local stress on the T-shaped structural to-be-welded parts, and achieve a stable torsion resistance of the T-shaped structural to-be-welded parts in a clamping process.

In an implementation mode, the Y-shaped connecting rod is connected to the stringer pressing plate in a threaded manner, and the skin connecting rod is connected to the skin pressing plate in a threaded manner, thereby facilitating replacement of pressing structural parts having different sizes.

In an implementation mode, each of the stringer pressing plate, the skin supporting table and the skin pressing plate is internally provided with a mechanical sensor that is configured to observe and record conditions of press on the stringer and the skin in real time and feed back the conditions to the control system.

In an implementation mode, the guide-track groove has a size of 120 mm×50 mm×30 mm, a vertical distance between the guide-track grooves and a long side of the base plate is 15 mm, there are a plurality of guide-track grooves, a distance between two adjacent guide-track grooves of the plurality of guide-track grooves is 100 mm, the ball screw is located in the guide-track groove, and a height of the ball screw relative to a bottom of the guide-track groove is adjustable, with an adjustment range of 10 mm-20 mm.

In an implementation mode, there are two ranging systems that are placed diagonally with respect to the stringer, so as to reduce measurement errors; and a vertical distance between the lateral laser range finder and a long side of the base plate is 15 mm, and a vertical distance between the longitudinal laser range finder and the long side of the base plate is 125 mm.

In an implementation mode, the clamping system controls the Y-shaped connecting rod and the skin connecting rod by means of a pneumatic device; and controls the ball screw, the lifting connecting rod and the gear connecting rod by means of a servo motor.

In an implementation mode, there are a plurality of guide-track grooves, a plurality of central columns, a plurality of Y-shaped connecting rods, a plurality of stringer pressing plates, two central columns of the plurality of central columns are placed in each of the plurality of guide-track grooves, two Y-shaped connecting rods of the plurality of Y-shaped connecting rods are connected with the two central columns respectively, the two Y-shaped connecting rods are arranged on both sides of the stringer, each of the Y-shaped connecting rod is connected to two stringer pressing plates of the plurality of stringer pressing plates.

In an implementation mode, the plurality of guide-track grooves are arranged along a long side of the base plate.

In an implementation mode, each of the plurality of guide-track grooves is extended along a wide side of the base plate.

A method for backside laser penetration welding of T-shaped structure, which is configured to implement backside laser penetration welding of T-shaped structural to-be-welded parts having different sizes and different welding positions and control a postwelding distortion of the T-shaped structural to-be-welded parts, and includes:
prewelding clamping, flexibly clamping the T-shaped structural to-be-welded parts by a flexible automatic clamping device in an automatic, locked, torsion-resistant and releasable manner;
backside laser penetration welding, and specifically, applying a laser heat source having a high energy density and a desirable penetrability to a to-be-welded position based on the flexible automatic clamping device, and making a melten weld pool penetrate a skin and a stringer, so as to achieve the backside laser penetration welding of the T-shaped structural to-be-welded parts; and
postwelding shape retention, continuously clamping the T-shaped structural to-be-welded parts after welding by the flexible automatic clamping device, so as to achieve a postwelding stress release and distortion control of the T-shaped structural to-be-welded parts.

In an implementation mode, adding a clamping pressure of 1000 N-1500 N by the flexible automatic clamping device after welding, and fixing the T-shaped structural to-be-welded parts for 12 h-24 h, so as to release a residual stress on the T-shaped structural to-be-welded parts under a constraint condition and achieve the distortion control.

The disclosure has the beneficial technical effects:

To solve a problem that double-laser-beam double-sided synchronous welding of an existing T-shaped skin-stringer structure cannot be implemented in a double-laser-beam double-sided synchronous welding process due to apparatus interference, assembly interference, etc., and problems of instability, non-torsion, non-releasing, poor flexibility, a low automation degree, etc. in a clamping process of the T-shaped skin-stringer structure, there are provided the flexible automatic clamping device and method for backside laser penetration welding of T-shaped structure. The flexible automatic clamping device flexibly and automatically clamps the T-shaped skin-stringer structure in a firm, torsion-resistant and releasable manner, and a systematic welding method consisting of flexible and automatic prewelding clamping, the backside laser penetration welding and postwelding shape retention is established, such that backside laser penetration weld seams of the T-shaped skin-stringer structure having high quality and excellent performance may be obtained, and a production cycle of welded products may be shortened. The disclosure may adjust a position and the clamping pressure of the clamping system according to changes of parameters such as a size of the T-shaped structural to-be-welded parts and a position of a weld seam, so as to flexibly and automatically clamp T-shaped skin-stringer structural to-be-welded parts having different sizes and different welding positions; may conduct the backside laser penetration welding on the T-shaped skin-stringer structural to-be-welded parts, so as to be applied to cases that a double-laser-beam double-sided synchronous welding method is not suitable for, and obtain high-quality weld seams; and may conduct post-welding shape retention on the T-shaped structural to-be-welded parts after welding is completed, release residual stress to control post-welding distortion, and may finally obtain welded products having high quality, strong performance and short production cycles.

### BRIEF DESCRIPTION OF THE DRAWINGS

FIG. 1 shows a schematic diagram of a clamping system of a flexible automatic clamping device in the disclosure;

FIG. 2 shows an operation schematic diagram of a flexible automatic clamping device in the disclosure;

FIG. 3 shows a local schematic diagram of a clamping system of a flexible automatic clamping device in the disclosure;

FIG. 4 shows a front view of a ranging system and a clamping system of a flexible automatic clamping device in the disclosure;

FIG. 5 shows a front view of a ranging system and a clamping system, after adjustment according to a size of the T-shaped structural to-be-welded parts and a position of a weld seam, of a flexible automatic clamping device in the disclosure; and

FIG. 6 shows a flow diagram of a method for backside laser penetration welding of T-shaped structure in the disclosure.

### REFERENCE SIGNS

200: a clamping system; 300: a ranging system; 400: a control system;

201: a base plate; 202: a central column; 203: a ball screw; 204: a Y-shaped connecting rod; 205: a stringer pressing plate; 206: a stringer; 207: a lifting connecting rod; 208: a skin supporting table; 209: a skin; 210: a gear connecting rod; 211: a skin cover plate; 212: a skin connecting rod; 213: a skin pressing plate; and

301: a lateral laser range finder; 302: a longitudinal laser range finder.

### DETAILED DESCRIPTION OF THE EMBODIMENTS

The disclosure will be further described in detail below with reference to the accompanying drawings and embodiments. It may be understood that specific embodiments described herein are merely used to explain the disclosure, but not limit the disclosure. In addition, it should be noted that, for the convenience of description, some rather than all of structures related to the disclosure are merely shown in the accompanying drawings.

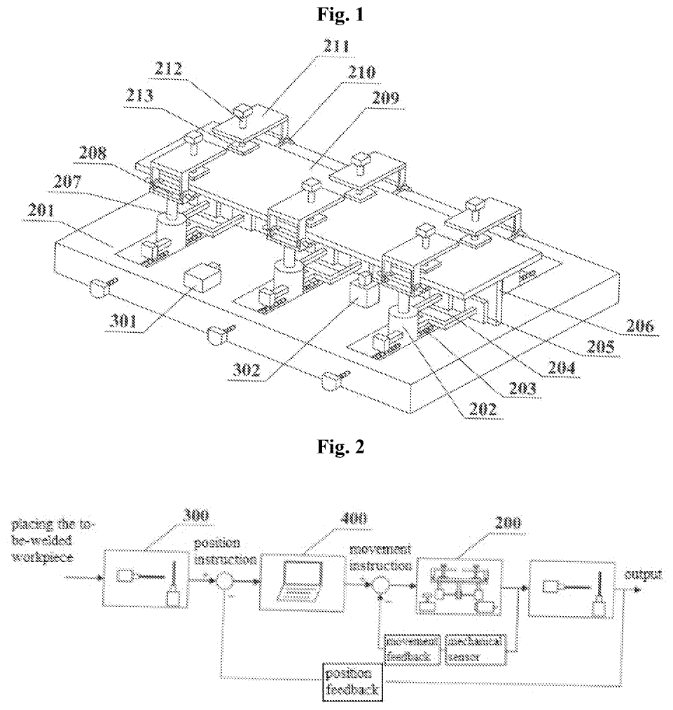

With reference to FIGS. 1, 2 and 6, the disclosure discloses a flexible automatic clamping device and method for backside laser penetration welding of T-shaped structure. The flexible automatic clamping device includes a clamping system 200, a ranging system 300 and a control system 400. The clamping system 200 includes a base plate 201, a central column 202, a ball screw 203, a Y-shaped connecting rod 204, a stringer pressing plate 205, a stringer 206, a lifting connecting rod 207, a skin supporting table 208, a skin 209, a gear connecting rod 210, a skin cover plate 211, a skin connecting rod 212, and a skin pressing plate 213. The base plate 201 is provided with a guide-track groove, and the central column 202 is placed in the guide-track groove and connected to the ball screw 203, so as to achieve a lateral adjustment of the central column 202; the Y-shaped connecting rod 204 is arranged in the middle of the central column 202 and connected to the stringer pressing plate 205, so as to clamp and fasten the stringer 206; the lifting connecting rod 207 is arranged above the central column 202, so as to adjust a height of the skin supporting table 208 in real time, and the skin supporting table 208 is configured to support the skin 209 and connected to the skin cover plate 211 by means of the gear connecting rod 210, so as to open and close the skin cover plate 211 and facilitate mounting and dismounting of the skin 209; and the skin cover plate 211 is connected to the skin pressing plate 213 by means of the skin connecting rod 212, so as to clamp and fasten the skin 209. The ranging system 300 includes a lateral laser range finder 301 and a longitudinal laser range finder 302. Based on the flexible automatic clamping device, the method includes prewelding clamping, backside laser penetration welding and postwelding shape retention.

In the embodiment, there are a plurality of guide-track grooves, a plurality of central columns, a plurality of Y-shaped connecting rods, a plurality of stringer pressing plates, two central columns of the plurality of central columns are placed in each of the plurality of guide-track grooves, two Y-shaped connecting rods of the plurality of Y-shaped connecting rods are connected with the two central columns respectively, the two Y-shaped connecting rods are arranged on both sides of the stringer, each of the Y-shaped connecting rod is connected to two stringer pressing plates of the plurality of stringer pressing plates.

In the embodiment, pressing structural parts comprising the stringer pressing plate 205 and the skin pressing plate 213 are all made of high temperature resistant rubber material, so as to increase contact areas between the pressing structural parts and the stringer 206 as well as the skin 209, reduce a local stress on the T-shaped structural to-be-welded parts, and achieve a stable torsion resistance of the T-shaped structural to-be-welded parts in a clamping process.

In the embodiment, the Y-shaped connecting rod 204 is connected to the stringer pressing plate 205 in a threaded manner, and the skin connecting rod 212 is connected to the skin pressing plate 213 in a threaded manner, thereby facilitating replacement of pressing structural parts having different sizes.

In the embodiment, each of the stringer pressing plate 205, the skin supporting table 208 and the skin pressing plate 213 is internally provided with a mechanical sensor that is configured to observe and record conditions of press on the stringer 206 and the skin 209 in real time and feed back the conditions to the control system 400.

In the embodiment, the guide-track groove have a size of 120 mm×50 mm×30 mm, a vertical distance between the guide-track groove and a long side of the base plate 201 is 15 mm, a distance between two adjacent guide-track grooves of the plurality of guide-track grooves is 100 mm, the ball screw 203 is located in the guide-track groove, and a height of the ball screw 203 relative to a bottom of the guide-track groove is adjustable, with an adjustment range of 10 mm-20 mm.

In the embodiment, there are two ranging systems that are placed diagonally with respect to the stringer 206, so as to reduce measurement errors, a vertical distance between the lateral laser range finder 301 and a long side of the base plate 201 is 15 mm, and a vertical distance between the longitudinal laser range finder 302 and the long side of the base plate 201 is 125 mm.

In the embodiment, the clamping system 200 controls the Y-shaped connecting rod 204 and the skin connecting rod 212 by means of a pneumatic device; and controls the ball screw 203, the lifting connecting rod 207 and the gear connecting rod 210 by means of a servo motor.

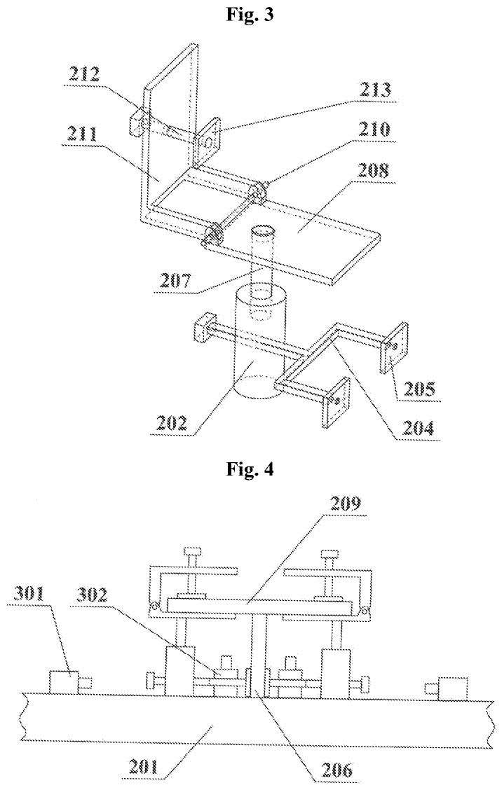

With reference to FIGS. 1, 2 and 3, firstly, the skin cover plate 211 is opened, and the stringer 206 and the skin 209 which are to-be-welded, are placed on the base plate 201 and the skin supporting table 208 respectively; then the lateral laser range finder 301 obtains a thickness of the stringer 206, the longitudinal laser range finder 302 obtains a height of the skin 209, and the ranging system 300 outputs a measured position instruction to the control system 400; according to feedback data, the control system 400 retrieves an appropriate movement instruction from a database and outputs the instruction to the clamping system 200; the clamping system 200 controls the ball screw 203, the lifting connecting rod 207 and the gear connecting rod 210 to move by means of a servo motor, such that the central column 202 and the skin supporting table 208 are at optimal positions and the skin cover plate 211 is closed; after a position of the clamping system 200 is determined, the control system 400 retrieves corresponding clamping pressure data from the database and outputs the data to the clamping system 200; and the clamping system 200 controls the Y-shaped connecting rod 204 and the skin connecting rod 212 to move by means of a pneumatic device, so as to clamp and fasten the stringer 206 and the skin 209 by the stringer pressing plate 205 and the skin pressing plate 213, and feeds back the movement instruction to the control system 400 in real time by means of mechanical sensors in the stringer pressing plate 205, the skin supporting table 208 and the skin pressing plate 213.

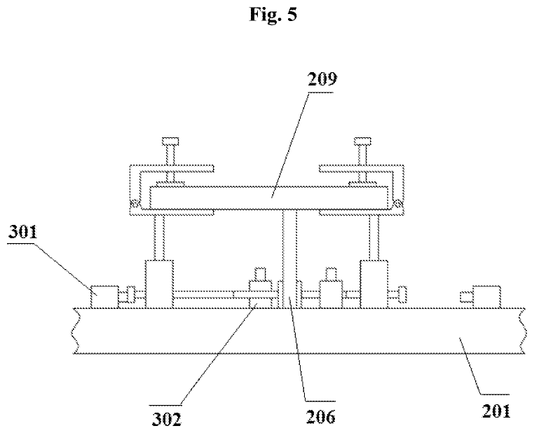

With reference to FIGS. 4 and 5, according to the T-shaped structural to-be-welded parts having different sizes and different welding positions, the clamping system 200, the ranging system 300 and the control system 400 are adjusted through coordination, such that the clamping system 200 reaches a corresponding optimal position, and implements a corresponding optimal fastening solution. The control system 400 is configured to adjust the clamping system 200 on the basis of data measured by the ranging system 300, so as to position the clamping system 200 at an optimal position, and configured to obtain an optimal pressure parameter from a database according to the obtained data, output the optimal pressure parameter to the clamping system 200, and implement the optimal fastening solution for the T-shaped structural to-be-welded parts.

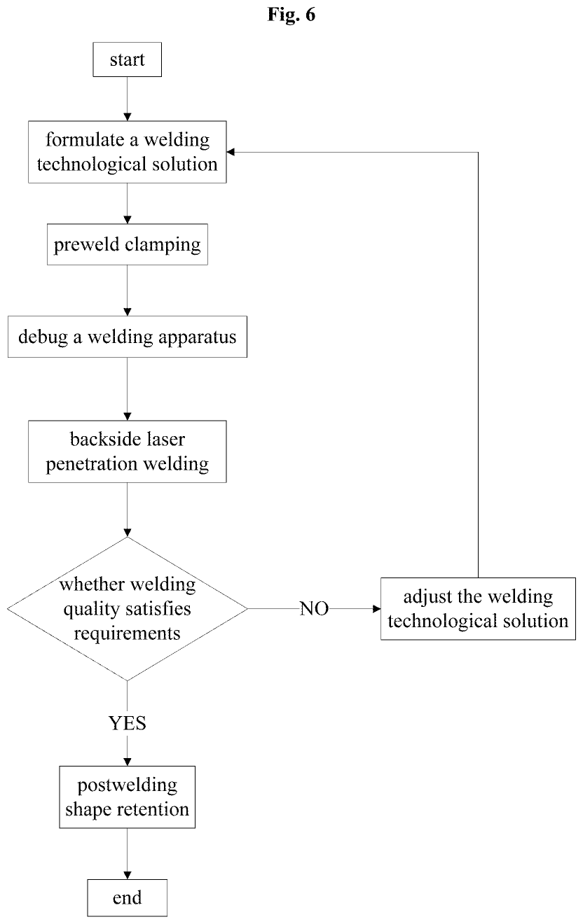

With reference to FIG. 6, firstly, before welding, a corresponding technological solution is formulated, and prewelding clamping of the T-shaped structural to-be-welded parts is completed by the flexible automatic clamping device; then with a welding robot and a laser generator adjusted, a welding position, a laser incident angle, a defocusing amount, etc. are corrected, and a laser power and a welding speed are set; after debugging, backside laser penetration welding is conducted on the T-shaped structural to-be-welded parts, and shielding gas is used to protect a weld seam in a welding process; and after welding, postwelding shape retention is conducted on the T-shaped structural to-be-welded parts, that is, adding a clamping pressure of 1000N-1500N by the flexible automatic clamping device, and fixing the T-shaped structural to-be-welded parts for 12 h-24 h, so as to release a residual stress on the T-shaped structural to-be-welded parts under a constraint condition and achieve distortion control.

With a flexible automatic clamping device and method for backside laser penetration welding of a T-shaped structure as examples, a complete process of assembly and use of the disclosure will be described below.

Firstly, the skin cover plate 211 is opened, and the stringer 206 and the skin 209 which are to-be-welded, are placed on the base plate 201 and the skin supporting table 208 respectively; then the lateral laser range finder 301 measures a thickness of the stringer 206 to be 2 mm, the longitudinal laser range finder 302 measures a height of the skin 209 to be 50 mm, and the ranging system 300 outputs a measured position instruction to the control system 400; according to feedback data, the control system 400 retrieves a movement instruction for not moving the ball screw 203 and lifting the lifting connecting rod 207 by 35 mm from a database and outputs the instruction to the clamping system 200; the clamping system 200 controls the lifting connecting rod 207 to be lifted by 35 mm and controls the gear connecting rod 210 to rotate by means of the servo motor, so as to close the skin cover plate 211; after a position of the clamping system 200 is determined, the control system 400 retrieves clamping pressure of 1000N from the database and outputs the clamping pressure to the clamping system 200; and the clamping system 200 controls the Y-shaped connecting rod 204 and the skin connecting rod 212 to move by means of the pneumatic device, so as to clamp and fasten the stringer 206 and the skin 209 by the stringer pressing plate 205 and the skin pressing plate 213, and feeds back the movement instruction to the control system 400 in real time by means of mechanical sensors in the stringer pressing plate 205, the skin supporting table 208 and the skin pressing plate 213.

Secondly, after the T-shaped structural to-be-welded parts is determined to be clamped, process parameters are adjusted according to the technological solution formulated in advance. The welding robot used in the embodiment is a KUKA robot. The KUKA robot is controlled to make a laser beam perpendicular to a to-be-welded weld seam, with a defocusing amount of the laser beam being 0 mm. The welding speed is set at 22 mm·s⁻¹, and a start position and an end position are set. A laser generator used is TruDisk-12003, and the laser power is adjusted to 2400 W. Argon of 99.99% is introduced for protection. After debugging, backside laser penetration welding is conducted on the above T-shaped structure.

Finally, after welding, adding an additional clamping pressure of 1000N to the T-shaped structural to-be-welded parts by the flexible automatic clamping device, and fixing the T-shaped structural to-be-welded parts for 14 h, so as to release the residual stress on the T-shaped structural to-be-welded parts under a constraint condition and achieve the distortion control.

The base plate 201, the central column 202, the lifting connecting rod 207, the skin supporting table 208, the skin cover plate 208, bolts, etc. may be made of ferrous metals, which include, but are not limited to, alloys of various designations such as cold work die steel, hot work die steel and stainless steel.

Obviously, the above embodiments of the disclosure are merely examples given for clearly illustrating the disclosure, and are not intended to limit implementations of the disclosure. According to the idea of the disclosure, those of ordinary skill in the art may change specific implementations and an application scope, and the content of the description should not be construed as a limitation of the disclosure. Any modifications, equivalent substitutions, improvements, etc. within the spirit and principles of the disclosure are intended to fall within the protection scope of claims of the disclosure.

What is claimed is:

1. A flexible automatic clamping device for backside laser penetration welding of T-shaped structure, which is configured to flexibly clamp T-shaped structural to-be-welded parts having different sizes and different welding positions in an automatic, locked, torsion-resistant and releasable manner, and comprising:
a clamping system, the clamping system comprises a base plate, a central column, a ball screw, a Y-shaped connecting rod, a stringer pressing plate, a stringer, a lifting connecting rod, a skin supporting table, a skin, a gear connecting rod, a skin cover plate, a skin connecting rod, and a skin pressing plate; the base plate is provided with a guide-track groove, and the central column is placed in the guide-track groove and connected to the ball screw, so as to achieve a lateral adjustment of the central column; the Y-shaped connecting rod is arranged in the middle of the central column and connected to the stringer pressing plate, so as to clamp and fasten the stringer; the lifting connecting rod is arranged above the central column, so as to adjust a height of the skin supporting table in real time, and the skin supporting table is configured to support the skin and connected to the skin cover plate by means of the gear connecting rod, so as to open and close the skin cover plate and facilitate mounting and dismounting of the skin; and the skin cover plate is connected to the skin pressing plate by means of the skin connecting rod, so as to clamp and fasten the skin;
a ranging system, the ranging system comprises a lateral laser range finder and a longitudinal laser range finder that are configured to measure and record a thickness of the stringer and a height of the skin in real time, so as to achieve accurate positioning of the stringer and the skin; and
a control system, which is configured to adjust the clamping system on the basis of data measured by the ranging system, so as to position the clamping system at an optimal position, and configured to obtain an optimal pressure parameter from a database according to the obtained data, output the optimal pressure parameter to the clamping system, and implement an optimal fastening solution for the T-shaped structural to-be-welded parts.

2. The flexible automatic clamping device for backside laser penetration welding of T-shaped structure according to claim 1, wherein pressing structural parts comprising the stringer pressing plate and the skin pressing plate are all made of high temperature resistant rubber material, so as to increase contact areas between the pressing structural parts and the stringer as well as the skin, reduce a local stress on the T-shaped structural to-be-welded parts, and achieve a stable torsion resistance of the T-shaped structural to-be-welded parts in a clamping process.

3. The flexible automatic clamping device for backside laser penetration welding of T-shaped structure according to claim 1, wherein the Y-shaped connecting rod is connected to the stringer pressing plate in a threaded manner, and the skin connecting rod is connected to the skin pressing plate in a threaded manner, thereby facilitating replacement of pressing structural parts having different sizes.

4. The flexible automatic clamping device for backside laser penetration welding of T-shaped structure according to claim 1, wherein each of the stringer pressing plate, the skin supporting table and the skin pressing plate is internally provided with a mechanical sensor that is configured to observe and record conditions of press on the stringer and the skin in real time and feed back the conditions to the control system.

5. The flexible automatic clamping device for backside laser penetration welding of T-shaped structure according to claim 1, wherein the guide-track groove have a size of 120 mm×50 mm×30 mm, a vertical distance between the guide-track groove and a long side of the base plate is 15 mm, there are a plurality of guide-track grooves, a distance between two adjacent guide-track grooves of the plurality of guide-track grooves is 100 mm, the ball screw is located in the guide-track groove, and a height of the ball screw relative to a bottom of the guide-track groove is adjustable, with an adjustment range of 10 mm-20 mm.

6. The flexible automatic clamping device for backside laser penetration welding of T-shaped structure according to claim 1, wherein there are two ranging systems that are placed diagonally with respect to the stringer, so as to reduce measurement errors, a vertical distance between the lateral laser range finder and a long side of the base plate is 15 mm, and a vertical distance between the longitudinal laser range finder and the long side of the base plate is 125 mm.

7. The flexible automatic clamping device for backside laser penetration welding of T-shaped structure according to claim 1, wherein the clamping system controls the Y-shaped connecting rod and the skin connecting rod by means of a pneumatic device; and controls the ball screw, the lifting connecting rod and the gear connecting rod by means of a servo motor.

8. The flexible automatic clamping device for backside laser penetration welding of T-shaped structure according to claim 1, wherein there are a plurality of guide-track grooves, a plurality of central columns, a plurality of Y-shaped connecting rods, a plurality of stringer pressing plates, two central columns of the plurality of central columns are placed in each of the plurality of guide-track grooves, two Y-shaped connecting rods of the plurality of Y-shaped connecting rods are connected with the two central columns respectively, the two Y-shaped connecting rods are arranged on both sides of the stringer, each of the Y-shaped connecting rod is connected to two stringer pressing plates of the plurality of stringer pressing plates.

9. The flexible automatic clamping device for backside laser penetration welding of T-shaped structure according to claim 8, wherein the plurality of guide-track grooves are arranged along a long side of the base plate.

10. The flexible automatic clamping device for backside laser penetration welding of T-shaped structure according to claim 8, wherein each of the plurality of guide-track grooves is extended along a wide side of the base plate.

11. A method for backside laser penetration welding of a T-shaped structure, which is configured to implement backside laser penetration welding of T-shaped structural to-be-welded parts having different sizes and different welding positions and control a postwelding distortion of the T-shaped structural to-be-welded parts, and comprising:
preweld clamping, flexibly clamping the T-shaped structural to-be-welded parts by a flexible automatic clamping device in an automatic, locked, torsion-resistant and releasable manner;
backside laser penetration welding, applying a laser heat source having a high energy density and a desirable penetrability to a to-be-welded position based on the flexible automatic clamping device, and making a melten weld pool penetrate a skin and a stringer, so as to achieve the backside laser penetration welding of the T-shaped structural to-be-welded parts; and
postwelding shape retention, continuously clamping the T-shaped structural to-be-welded parts after welding by the flexible automatic clamping device, so as to achieve a postwelding stress release and a distortion control of the T-shaped structural to-be-welded parts.

12. The method for backside laser penetration welding of T-shaped structure according to claim 11, wherein the postwelding shape retention comprises adding a clamping pressure of 1000N-1500N by the flexible automatic clamping device after welding, and fixing the T-shaped structural to-be-welded parts for 12 h-24 h, so as to release a residual stress on the T-shaped structural to-be-welded parts under a constraint condition and achieve the distortion control.
